(19) United States
(12) Patent Application Publication
(10) Pub. No.: US 2026/0100460 A1
(43) Pub. Date: Apr. 9, 2026

(54) ELECTRICAL ENERGY STORAGE MODULE AND SPACER USED FOR THE SAME

(71) Applicant: Prime Planet Energy & Solutions, Inc., Tokyo (JP)

(72) Inventors: Tsutomu TERAMOTO, Kariya-shi (JP); Tetsuji OMURA, Kobe-shi (JP)

(21) Appl. No.: 19/348,788

(22) Filed: Oct. 3, 2025

(30) Foreign Application Priority Data
Oct. 7, 2024 (JP) 2024-176156

(51) Int. Cl. H01M 50/242; H01M 50/209; H01M 50/291; H01M 50/293

(52) U.S. Cl. CPC H01M 50/242; H01M 50/291; H01M 50/293; H01M 50/209

(57) ABSTRACT

An electrical energy storage module disclosed herein includes a first electrical energy storage device and a second electrical energy storage device, and a spacer. The spacer includes a base part and a plurality of tubular protrusion parts. The tubular protrusion part includes a peripheral wall part and a hollow part surrounded by the peripheral wall part. The peripheral wall part includes a first part and a second part. The hollow part is provided with deviation to one side from a center of the tubular protrusion parts in a plan view. When a predetermined load is applied from an arrangement direction, the first part of the peripheral wall part is compressed and deformed and the second part of the peripheral wall part is buckled.

### CROSS REFERENCE TO RELATED APPLICATION

This application claims the benefit of priority to Japanese Patent Application No. 2024-176156 filed on Oct. 7, 2024. The entire contents of this application are hereby incorporated herein by reference.

### BACKGROUND OF THE DISCLOSURE

### 1. Field

The present disclosure relates to an electrical energy storage module and a spacer used for the same.

### 2. Background

Conventionally, an electrical energy storage module including a plurality of electrical energy storage devices disposed along an arrangement direction, a spacer disposed between the plurality of electrical energy storage devices, and a restriction mechanism that restricts the plurality of electrical energy storage devices and the spacer in the arrangement direction has been widely used (for example, Japanese Patent Application Publication No. 2023-84271, Japanese Patent Application Publication No. 2023-83690, and Japanese Patent Application Publication No. 2014-102939).

For example, Japanese Patent Application Publication No. 2023-84271 discloses a spacer including a base part with a flat plate shape and a plurality of protrusion parts with a circular cylindrical shape that project from the base part toward the electrical energy storage device. According to Japanese Patent Application Publication No. 2023-84271, when the electrical energy storage device expands, the protrusion part is compressed and deformed so that the cross section thereof is enlarged, making it possible to absorb the expansion of the electrical energy storage device.

### SUMMARY

The electrical energy storage devices with the capacity increased in recent years tend to expand largely. Accordingly, the compression rate of the protrusion part of the spacer tends to become high. The present inventors' examination indicates that when the compression rate of the protrusion part becomes high, the expansion of the electrical energy storage device cannot be absorbed completely just by “the compression and deformation” of the protrusion part, resulting in a risk that the reaction force for the electrical energy storage device suddenly increases. In view of this, a novel structure that can press the electrical energy storage device with a predetermined load stably has been required.

The present disclosure has been made in view of the above circumstances, and a main object thereof is to provide a novel electrical energy storage module that can stably press an electrical energy storage device, and a spacer.

An electrical energy storage module according to the present disclosure includes a first electrical energy storage device and a second electrical energy storage device that are disposed along an arrangement direction, a spacer that is disposed between the first electrical energy storage device and the second electrical energy storage device, and a restriction mechanism that restricts the first electrical energy storage device, the second electrical energy storage device, and the spacer in the arrangement direction. The spacer includes a base part with a flat plate shape, and a plurality of tubular protrusion parts projecting from the base part to a side of the first electrical energy storage device. Each of the plurality of tubular protrusion parts includes a peripheral wall part extending to the side of the first electrical energy storage device, and a hollow part surrounded by the peripheral wall part. The peripheral wall part includes a first part with relatively large thickness and a second part with relatively small thickness. The hollow part is provided with deviation to one side from a center of the tubular protrusion part in a plan view. When a predetermined load is applied from the arrangement direction, the first part of the peripheral wall part is compressed and deformed and the second part of the peripheral wall part is buckled.

In the aforementioned spacer, when the electrical energy storage device expands and the predetermined load is applied from the arrangement direction, the second part of the tubular protrusion part is buckled partially. Thus, even when the compression rate of the tubular protrusion part becomes high, the increase in reaction force can be suppressed. As a result, the application of excessive load on the electrical energy storage device can be suppressed and the electrical energy storage device can be stably pressed.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a perspective view schematically illustrating an electrical energy storage module according to an embodiment;

FIG. 2 is a perspective view schematically illustrating an electrical energy storage device in FIG. 1;

FIG. 3 is a schematic longitudinal cross-sectional view taken along line III-III in FIG. 2;

FIG. 4 is a perspective view schematically illustrating a spacer in FIG. 1;

FIG. 5 is a perspective view schematically illustrating a tubular protrusion part;

FIG. 6 is a plan view schematically illustrating the tubular protrusion part;

FIG. 7 represents results of simulation in which the tubular protrusion part in FIG. 5 is compressed;

FIG. 8 represents results of simulation in which the tubular protrusion part in FIG. 6 is compressed;

FIG. 9 is a schematic longitudinal cross-sectional view taken along line IV-IV in FIG. 8;

FIG. 10A and FIG. 10B are explanatory views for describing the concept of the art disclosed herein;

FIG. 11 represents results of simulation expressing a relation between a compression rate and a reaction force; and

FIG. 12A to FIG. 12C are views of tubular protrusion parts according to modifications, corresponding to FIG. 6.

### DETAILED DESCRIPTION OF THE PREFERRED EMBODIMENTS

Hereinafter, preferred embodiments of an electrical energy storage module disclosed herein will be described with reference to the drawings as appropriate. Matters that are other than matters particularly mentioned in the present specification and that are necessary for the implementation of the present disclosure (for example, the general configuration and manufacturing process of an electrical energy storage module and an electrical energy storage device that do not characterize the present disclosure) can be grasped as design matters of those skilled in the art based on the prior art in the relevant field. An electrical energy storage module disclosed herein can be implemented on the basis of the disclosure of the present specification and common technical knowledge in the relevant field.

Note that in the drawings below, the members and parts with the same operation are denoted by the same reference sign and the overlapping description may be omitted or simplified. Moreover, in the present specification, the notation “A to B” for a range signifies a value more than or equal to A and less than or equal to B, and is meant to encompass also the meaning of being “preferably more than A” and “preferably less than B”.

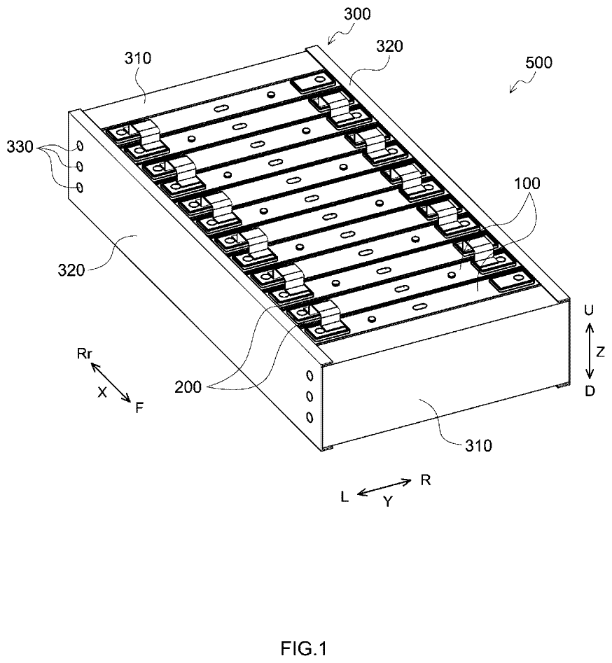

FIG. 1 is a perspective view schematically illustrating an electrical energy storage module 500 according to an embodiment. The electrical energy storage module 500 includes a plurality of electrical energy storage devices (a first electrical energy storage device and a second electrical energy storage device) 100 that are disposed along an arrangement direction X, a spacer 200 that is disposed between the electrical energy storage devices 100 (the first electrical energy storage device and the second electrical energy storage device) adjacent to each other in the arrangement direction X, and a restriction mechanism 300 that restricts the plurality of electrical energy storage devices 100 and the spacer 200 in the arrangement direction X. In the following description, reference signs F, Rr, L, R, U, and D in the drawings respectively denote front, rear, left, right, up, and down, and reference signs X, Y, and Z in the drawings respectively denote a thickness direction of the electrical energy storage device 100, a width direction that is orthogonal to the thickness direction, and a height direction that is orthogonal to the thickness direction and the width direction. The thickness direction X also corresponds to the arrangement direction of the electrical energy storage devices 100. These directions are defined however for convenience of explanation, and do not limit the manner in which the electrical energy storage module 500 is disposed.

The restriction mechanism 300 is a mechanism that restricts the plurality of electrical energy storage devices 100 and the spacer 200 in the arrangement direction X. The restriction mechanism 300 is configured to apply a predetermined restriction load on the plurality of electrical energy storage devices 100 and the spacer 200 from the arrangement direction X. The restriction mechanism 300 here includes a pair of end plates 310, a pair of side plates 320, and a plurality of screws 330. The pair of end plates 310 and the pair of side plates 320 are preferably made of a metal. However, the pair of end plates 310 and/or the pair of side plates 320 may be partially made of resin.

The pair of end plates 310 are disposed at both ends of the electrical energy storage module 500 in the arrangement direction X. The pair of end plates 310 hold the plurality of electrical energy storage devices 100 and the spacer 200 therebetween in the arrangement direction X.

The pair of side plates 320 link between the pair of end plates 310. The pair of side plates 320 are fixed to the end plates 310 by the plurality of screws 330 so that a restriction load is generally about 10 to 15 kN, for example. Thus, the restriction load is applied on the plurality of electrical energy storage devices 100 and the spacer 200 from the arrangement direction X and accordingly, the electrical energy storage module 500 is held integrally. The structure of the restriction mechanism is, however, not limited to this example. In another example, the restriction mechanism 300 may alternatively include a plurality of restriction bands, bind bars, or the like instead of the side plates 320.

The plurality of electrical energy storage devices 100 are arranged between the pair of end plates 310 along the arrangement direction X (the thickness direction X of the electrical energy storage device 100). The spacer 200 is disposed between the electrical energy storage devices 100 that are adjacent to each other in the arrangement direction X. In the arrangement direction X, the electrical energy storage devices 100 and the spacer 200 are arranged alternately.

The electrical energy storage device 100 is a device capable of being repeatedly charged and discharged. Note that in the present specification, the term “electrical energy storage device” refers to a concept encompassing secondary batteries such as lithium ion secondary batteries and nickel-hydrogen batteries and capacitors using a chemical reaction, such as lithium ion capacitors and pseudo-capacitors. Note that the shape, the size, the number, the arrangement, and the like of the plurality of electrical energy storage devices 100 included in the electrical energy storage module 500 are not limited to the aspect disclosed herein, and can be changed as appropriate.

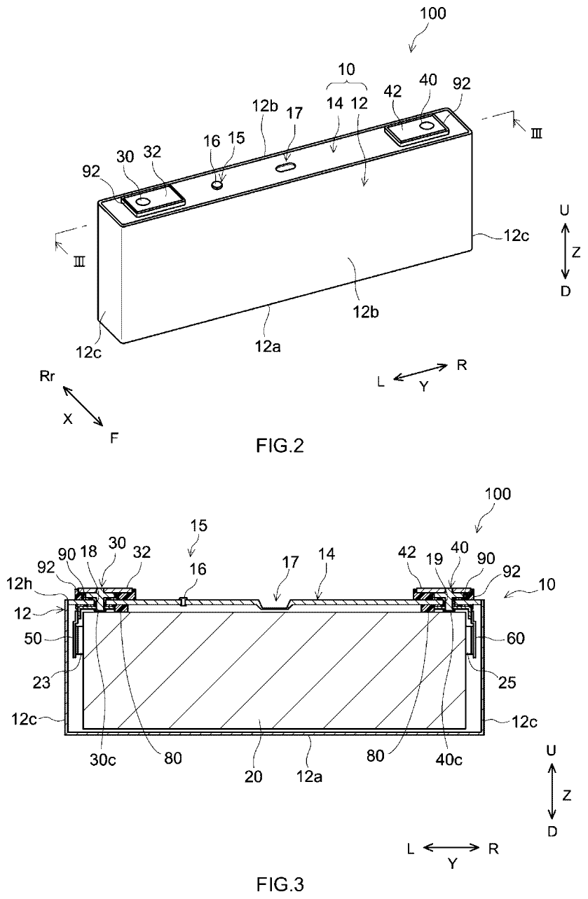

FIG. 2 is a perspective view of the electrical energy storage device 100. As illustrated in FIG. 1 and FIG. 2, every electrical energy storage device 100 has a flat and square shape, and has the same shape here. The plurality of electrical energy storage devices 100 are disposed so that their long side surfaces 12b to be described below face each other here. The plurality of electrical energy storage devices 100 are arranged so that the long side surfaces 12b become parallel to each other.

FIG. 3 is a schematic longitudinal cross-sectional view taken along line III-III in FIG. 2. As illustrated in FIG. 3, the electrical energy storage device 100 here includes a battery case 10, an electrode body 20, a positive electrode terminal 30, a negative electrode terminal 40, and an electrolyte solution (not illustrated). The electrical energy storage device 100 is a nonaqueous electrolyte solution secondary battery here, and specifically a lithium ion secondary battery.

The battery case 10 is a housing that accommodates the electrode body 20 and an electrolyte solution. As illustrated in FIG. 2, the external shape of the battery case 10 is a flat and bottomed cuboid shape (square shape). A conventionally used material can be used for the battery case 10, without particular limitations. The battery case 10 is preferably made of metal, and for example, more preferably made of aluminum, an aluminum alloy, iron, an iron alloy, or the like. As illustrated in FIG. 3, the battery case 10 includes an exterior body 12 including an opening 12h and a sealing plate (lid body) 14 that seals the opening 12h.

As illustrated in FIG. 2, the exterior body 12 includes a bottom surface 12a with a substantially rectangular shape including long sides and short sides, a pair of long side surfaces 12b extending from the long sides of the bottom surface 12a and facing each other, and a pair of short side surfaces 12c extending from the short sides of the bottom surface 12a and facing each other. The bottom surface 12a faces the opening 12h (see FIG. 3). Note that in the present specification, the term “substantially rectangular shape” encompasses, in addition to a perfect rectangular shape (rectangle), for example, a shape whose corner part connecting a long side and a short side of the rectangular shape is rounded (rounded corner), a shape whose corner part includes a notch, and the like.

The long side surface 12b is a surface facing the spacer 200. As illustrated in FIG. 2, the long side surface 12b is flat. The long side surface 12b is in direct contact with the spacer 200 here. In another embodiment, however, the long side surface 12b may face the spacer 200 through another member. In a plan view, the long side surface 12b is larger in area than the short side surface 12c. In a case of a high-capacity type that is used for a vehicle or the like, the area of the long side surface 12b may be about 10,000 mm² or more, and is preferably 15,000 mm² or more, more preferably 20,000 mm² or more, still more preferably 25,000 mm² or more, and particularly preferably 30,000 mm² or more, although there is no particular limitation.

As illustrated in FIG. 1, the sealing plate 14 has a substantially rectangular shape in the plan view. The sealing plate 14 is a plate-shaped member that extends along an XY plane as illustrated in FIG. 2. As illustrated in FIG. 3, the sealing plate 14 is attached to the exterior body 12 so as to cover the opening 12h. The sealing plate 14 faces the bottom surface 12a of the exterior body 12. The sealing plate 14 is substantially rectangular in shape. The battery case 10 is unified in a manner that the sealing plate 14 is joined (preferably, joined by welding) to a periphery of the opening 12h of the exterior body 12. The battery case 10 is hermetically sealed (closed).

As illustrated in FIG. 3, a liquid injection hole 15, a discharge valve 17, and two terminal extraction holes 18 and 19 are provided in the sealing plate 14. The liquid injection hole 15 is provided for the purpose of injecting the electrolyte solution into the battery case 10 after the sealing plate 14 is assembled to the exterior body 12. The liquid injection hole 15 is sealed by a sealing member 16. The discharge valve 17 is configured to break when the pressure in the battery case 10 becomes more than or equal to a predetermined value so as to discharge the gas out of the battery case 10. The terminal extraction holes 18 and 19 penetrate the sealing plate 14 in the height direction Z.

The positive electrode terminal 30 is disposed at an end part of the sealing plate 14 on one side in the width direction Y (left end part in FIG. 2 and FIG. 3). The negative electrode terminal 40 is disposed at an end part of the sealing plate 14 on the other side in the width direction Y (right end part in FIG. 2 and FIG. 3). As illustrated in FIG. 3, the positive electrode terminal 30 and the negative electrode terminal 40 are respectively inserted to the terminal extraction holes 18 and 19 and extend to the outside from the inside of the sealing plate 14. The positive electrode terminal 30 and the negative electrode terminal 40 are here caulked to a peripheral part of the sealing plate 14 that surrounds the terminal extraction holes 18 and 19 by a caulking process. Caulking parts 30c and 40c are formed at an end part of the positive electrode terminal 30 and the negative electrode terminal 40 on the exterior body 12 side (lower end part in FIG. 3). Thus, the positive electrode terminal 30 and the negative electrode terminal 40 are fixed to the sealing plate 14.

As illustrated in FIG. 3, the positive electrode terminal 30 is electrically connected to a positive electrode tab 23 of the electrode body 20 through a positive electrode current collecting member 50 inside the exterior body 12. The positive electrode terminal 30 is insulated from the sealing plate 14 by an internal insulation member 80 and a gasket 90. The negative electrode terminal 40 is electrically connected to a negative electrode tab 25 of the electrode body 20 through a negative electrode current collecting member 60 inside the exterior body 12. The negative electrode terminal 40 is insulated from the sealing plate 14 by the internal insulation member 80 and the gasket 90.

As illustrated in FIG. 2 and FIG. 3, a positive electrode external conductive member 32 and a negative electrode external conductive member 42, each having a plate shape, are attached to an external surface of the sealing plate 14. The positive electrode external conductive member 32 is electrically connected to the positive electrode terminal 30. The negative electrode external conductive member 42 is electrically connected to the negative electrode terminal 40. The positive electrode external conductive member 32 and the negative electrode external conductive member 42 are insulated from the sealing plate 14 by an external insulation member 92.

As illustrated in FIG. 1, a bus bar for electrically connecting the plurality of electrical energy storage devices 100 to each other is attached to the positive electrode external conductive member 32 and the negative electrode external conductive member 42. Here, in the two electrical energy storage devices 100 that are adjacent to each other in the arrangement direction X, the positive electrode external conductive member 32 of one electrical energy storage device 100 and the negative electrode external conductive member 42 of the other electrical energy storage device 100 are electrically connected to each other by the bus bar. Thus, the electrical energy storage module 500 is electrically connected in series. However, the connection method between the plurality of electrical energy storage devices 100 is not limited to the series connection and may be, for example, parallel connection, multiple series-multiple parallel connection, or the like.

The electrode body 20 includes a positive electrode and a negative electrode. The structure of the electrode body 20 may be similar to the conventional structure thereof, without particular limitations. The number of electrode bodies 20 to be disposed in one battery case 10 is not limited in particular and may be one or two or more (plural). The electrode body 20 here is a wound electrode body with a flat shape in which the positive electrode with a band shape and the negative electrode with a band shape are stacked via a separator in an insulated state and wound using a winding axis as a center. The positive electrode includes a positive electrode current collector with a band shape and a positive electrode active material layer provided in a band shape along a longitudinal direction of the positive electrode current collector here. The negative electrode includes a negative electrode current collector with a band shape and a negative electrode active material layer provided in a band shape along a longitudinal direction of the negative electrode current collector here. In another embodiment, however, the electrode body 20 may be a stack type electrode body formed in a manner that a plurality of square positive electrodes and a plurality of square negative electrodes are stacked in the insulated state.

As illustrated in FIG. 3, the positive electrode tab 23 is provided at one end part of the electrode body 20 in a winding axis direction (the width direction Y in FIG. 3). To the positive electrode tab 23, the positive electrode current collecting member 50 is attached. The positive electrode current collecting member 50 constitutes a conductive path that electrically connects the positive electrode terminal 30 and the positive electrode of the electrode body 20. In addition, the negative electrode tab 25 is provided at the other end part of the electrode body 20 in the winding axis direction (the width direction Y in FIG. 3). To the negative electrode tab 25, the negative electrode current collecting member 60 is attached. The negative electrode current collecting member 60 constitutes a conductive path that electrically connects the negative electrode terminal 40 and the negative electrode of the electrode body 20.

The electrolyte solution may be similar to the conventional electrolyte solution without particular limitations. The electrolyte solution is typically a nonaqueous electrolyte solution containing a nonaqueous solvent and a supporting salt (electrolyte salt). Examples of the nonaqueous solvent include carbonates, esters, ethers, nitriles, sulfones, lactones, and the like. Any of these can be used alone, or two or more kinds thereof can be used in combination. In particular, the carbonates are preferable. As the electrolyte salt, for example, a fluorine-containing lithium salt such as lithium hexafluorophosphate (LiPF₆) or lithium tetrafluoroborate (LiBF₄) can be used. The electrolyte solution may additionally contain an additive as necessary.

As illustrated in FIG. 1, the spacer 200 is disposed between the plurality of electrical energy storage devices 100 in the arrangement direction X here. However, it is only necessary that the spacer 200 is disposed between at least the two electrical energy storage devices (the first electrical energy storage device and the second electrical energy storage device) 100 that are adjacent in the arrangement direction X, and the spacer 200 is not necessarily disposed between all the electrical energy storage devices 100. The spacer 200 is in contact (direct contact) with the long side surface 12b of the electrical energy storage device 100 here. In another embodiment, however, another member (for example, a conventionally known heat insulating material or the like) may be provided between the electrical energy storage device 100 and the spacer 200.

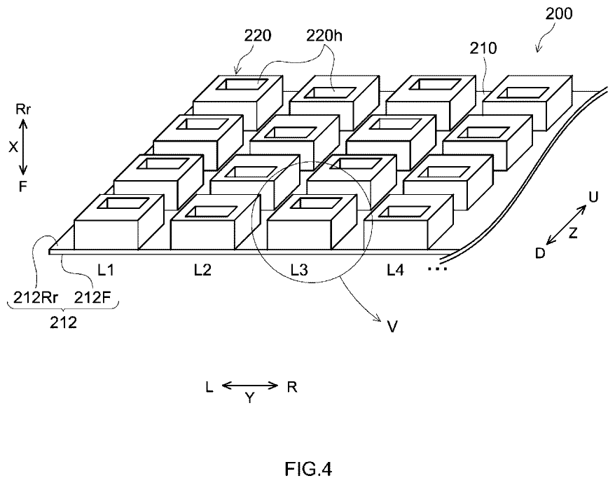

FIG. 4 is a perspective view schematically illustrating the spacer 200. As illustrated in FIG. 4, the spacer 200 includes a base part 210 and a plurality of tubular protrusion parts 220. The base part 210 and the plurality of tubular protrusion parts 220 are formed integrally here. The material of the spacer 200 (the base part 210 and the plurality of tubular protrusion parts 220) is not limited in particular but is preferably a polymer material. More preferable examples thereof include rubbers (thermosetting elastomers) such as silicone rubber, fluorine rubber, urethane rubber, natural rubber, styrene butadiene rubber, butyl rubber, ethylene propylene rubber (EPM, EPDM), butadiene rubber, isoprene rubber, and norbornene rubber. In particular, silicone rubber and EPDM are preferable.

In some embodiments, the spacer 200 preferably has an insulating property. In this specification, the term “insulating property” refers to a volume resistivity, which is measured based on JIS K6911:2006, of 1.0×10¹⁰ Ω·cm or more. The volume resistivity of the spacer 200 is preferably 1.0×10¹² Ω·cm or more.

The base part 210 is a part having a flat plate shape and substantially uniform thickness. The thickness of the base part 210 (the length in the arrangement direction X) is preferably about 0.1 to 5 mm and more preferably 0.3 to 2 mm, although there is no particular limitation. The provision of the base part 210 makes it possible to improve the productivity or workability when disposing the spacer 200 between the plurality of electrical energy storage devices 100.

As illustrated in FIG. 4, the base part 210 includes a pair of opposing surfaces 212 that intersect with the arrangement direction X and expand along a YZ plane. Each of the opposing surfaces 212 is a surface facing the electrical energy storage device 100 (specifically, the long side surface 12b). The size of the opposing surface 212, that is, the height (the length in the height direction Z) and/or the width (the length in the width direction Y) thereof is preferably substantially the same (about ±1 cm) as the size of the opposing surface (here, the long side surface 12b) of the electrical energy storage device 100, that is, the height and/or the width thereof. This makes it easier to position with respect to the electrical energy storage device 100 and accordingly, the productivity or the workability of the electrical energy storage module 500 can be improved.

The plurality of tubular protrusion parts 220 project from one opposing surface 212Rr of the base part 210 (a surface facing the first electrical energy storage device 100). Here, the other opposing surface 212F of the base part 210 (a surface facing the second electrical energy storage device 100) has a flat surface and does not include the plurality of tubular protrusion parts 220. That is to say, out of the pair of opposing surfaces 212 of the base part 210, only one opposing surface 212Rr includes the plurality of tubular protrusion parts 220. In another embodiment, however, the plurality of tubular protrusion parts 220 may be provided also on the other opposing surface 212F of the base part 210. In other words, the base part 210 may include the plurality of tubular protrusion parts 220 on each of the pair of opposing surfaces 212.

Each of the plurality of tubular protrusion parts 220 is a part that projects from the base part 210 toward the first electrical energy storage device 100 (on a rear side in FIG. 4). The plurality of tubular protrusion parts 220 extend toward the long side surface 12b of the first electrical energy storage device 100 here. The plurality of tubular protrusion parts 220 are disposed regularly on one opposing surface 212Rr of the base part 210. The plurality of tubular protrusion parts 220 exist in a scattering manner in an island (spot)-like shape on the opposing surface 212Rr of the base part 210. The plurality of tubular protrusion parts 220 have the same size and shape here. At the opposing surface 212Rr of the base part 210, a predetermined gap is secured between the adjacent tubular protrusion parts 220. In some embodiments, it is preferable that the adjacent tubular protrusion parts 220 be disposed so as not to be in contact with each other even when the restriction load is applied from the arrangement direction X.

In some embodiments, the tubular protrusion part 220 that is disposed on the outermost edge side in the opposing surface 212Rr preferably exists on the inside relative to an outer edge of the long side surface 12b of the facing first electrical energy storage device 100. In addition, in some embodiments, one or more tubular protrusion parts 220 are preferably disposed in the range wider than a region that faces the electrode body 20 of the facing first electrical energy storage device 100 (a region of the electrode body 20 that is in contact with the long side surface 12b of the battery case 10, and particularly in a case of a wound electrode body, a flat part excluding a part with a curved shape). However, the shape, size, arrangement, and the like of the plurality of tubular protrusion parts 220 are not limited to the aspect illustrated in FIG. 4 and can be changed as appropriate in accordance with the shape, size, capacity, restriction load, and the like of the electrical energy storage device 100, for example. In addition, the shape, size, and interval of the plurality of tubular protrusion parts 220 may be different from each other.

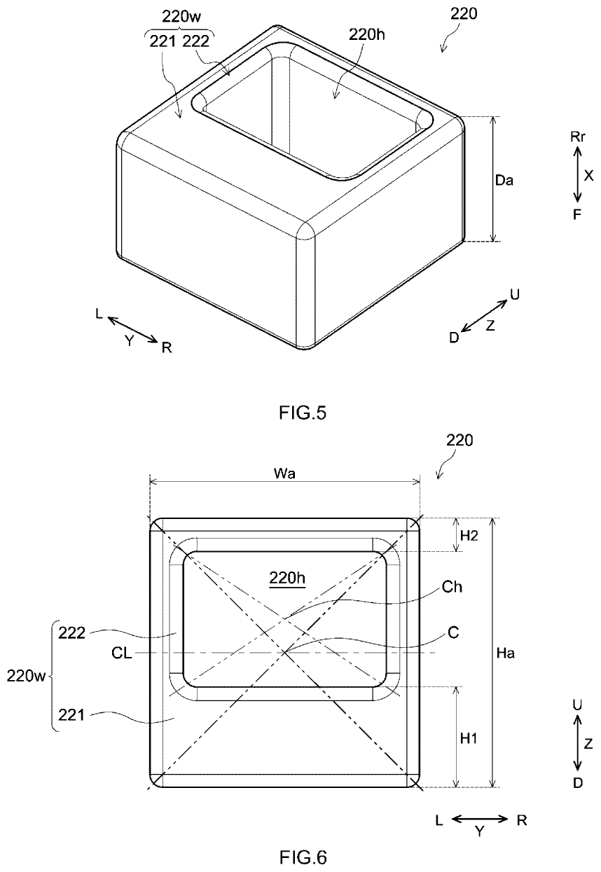

FIG. 5 is a perspective view schematically illustrating one tubular protrusion part 220. FIG. 6 is a plan view schematically illustrating one tubular protrusion part 220. As illustrated in FIG. 5, the outer shape of the tubular protrusion part 220 is a substantially prism shape (substantially quadrangular prism shape) here. In another embodiment, however, the outer shape of the tubular protrusion part 220 may be a circular cylindrical shape (including an elliptical cylindrical shape), or a substantially polygonal prism shape other than the quadrangular prism shape (such as a substantially triangular prism shape or a substantially hexagonal prism shape). Note that, in this specification, the term “substantially prism shape” encompasses, in addition to a perfect prism shape, a shape whose corner part connecting two sides has a rounded shape (rounded corner) as illustrated in FIG. 5, a shape having a notch at a corner part, and the like. This similarly applies to the other polygonal prism shapes that are described as “substantially X shapes” in this specification.

Although there is no particular limitation, as illustrated in FIG. 5, a projecting height Da (the length in the arrangement direction X) of the tubular protrusion part 220 is typically larger than the thickness of the base part 210, and is preferably about 1 to 10 mm, more preferably 1 to 8 mm, and still more preferably 3 to 5 mm in a state before the assembling to the electrical energy storage module 500 and the compression with the restriction mechanism 300. Each of a width (a length in the width direction Y) Wa and a height (a length in the height direction Z) Ha of the tubular protrusion part 220 is preferably about 2 to 30 mm, more preferably 3 to 20 mm, and still more preferably 5 to 10 mm as illustrated in FIG. 6. In some embodiments, the width Wa and the height Ha of the tubular protrusion part 220 are preferably the same.

As illustrated in FIG. 5 and FIG. 6, each of the plurality of tubular protrusion parts 220 includes a peripheral wall part 220w extending toward the first electrical energy storage device 100 (to the rear side in FIG. 5) and a hollow part 220h surrounded by the peripheral wall part 220w. The peripheral wall part 220w is provided in an annular shape and forms an outer edge of the tubular protrusion part 220. The peripheral wall part 220w includes a first part 221 with relatively large thickness and a second part 222 with relatively small thickness. The peripheral wall part 220w may further include a third part that is thinner than the first part 221 and thicker than the second part 222.

The first part 221 is a part that is configured to be compressed and deformed without bending when a predetermined load is applied from the arrangement direction X. Note that, in this specification, the term “compressed and deformed” refers to being crushed and deformed so that its cross section is enlarged. The first part 221 preferably has a so-called solid structure (filled structure) that does not have a hollow part or a gap. The first part 221 is a part including the thickest part of the peripheral wall part 220w. As illustrated in FIG. 6, the first part 221 has a substantially I-like shape in the plan view here. The first part 221 is provided in a band shape with substantially uniform thickness along one side (the width direction Y in FIG. 6) of the hollow part 220h on one side (on a lower side in FIG. 6) of the hollow part 220h here. Although there is no particular limitation, a thickness H1 of the first part 221 (an average length in the height direction Z) is preferably about 0.5 to 10 mm, more preferably 1 to 8 mm, and still more preferably 2 to 5 mm.

The second part 222 is a part that is configured to buckle when the predetermined load is applied from the arrangement direction X. Note that, in this specification, “buckle” means to curve with a certain load (buckling load) and wind (bend) in the arrangement direction X. As illustrated in FIG. 6, the second part 222 has a substantially U-like shape in the plan view here. The second part 222 includes a left part that is provided in a band shape with substantially uniform thickness along the height direction Z on a left side of the hollow part 220h, an upper part that is provided in a band shape with substantially uniform thickness along the width direction Y on an upper side of the hollow part 220h, and a right part that is provided in a band shape with substantially uniform thickness along the height direction Z on a right side of the hollow part 220h here. The second part 222 includes a rounded part whose corner part is rounded. The structure having the rounded corner part in this manner tends to wind (bend) because the deformation is different on the outside and inside of the rounded part in a loading process.

Although there is no particular limitation, a thickness H2 of the second part 222 (the average length of each of the left part, the upper part, and the right part) is preferably about 0.1 to 8 mm, more preferably 0.5 to 5 mm, and still more preferably 1 to 3 mm. When the thickness H2 is the predetermined value or less, the second part 222 has a shape that is long and thin in the arrangement direction X (the projecting height Da becomes long relative to the cross-sectional area). This makes buckling occur easily. Although there is no particular limitation, a ratio (H1/H2) of the thickness H1 of the first part 221 to the thickness H2 of the second part 222 is more than 1, and is preferably 1.2 to 10, more preferably 1.5 to 5, and still more preferably 2 to 4.

As illustrated in FIG. 5, the hollow part 220h is provided inside the peripheral wall part 220w. The outer shape of the hollow part 220h is a substantially prism shape (substantially quadrangular prism shape) here. The outer shape of the hollow part 220h is the same as the outer shape of the tubular protrusion part 220. In another embodiment, however, the outer shape of the hollow part 220h may be a circular cylindrical shape (including an elliptical cylindrical shape), or a substantially polygonal prism shape other than the quadrangular prism shape (such as a substantially triangular prism shape or a substantially hexagonal prism shape). Alternatively, the outer shape of the hollow part 220h may be different from the shape of the tubular protrusion part 220.

As illustrated in FIG. 6, the hollow part 220h has a substantially quadrangular shape, specifically a rectangular shape, in a plan view in which the tubular protrusion part 220 is viewed from a tip end side. In another embodiment, however, the hollow part 220h may have a substantially circular shape, a semi-circular shape, a semi-elliptical shape, or a substantially polygonal shape other than a quadrangular shape (for example, a substantially triangular shape) in the plan view. Note that, in this specification, the term “substantially circular shape” encompasses, in addition to a perfect circular shape (perfect circle), a circular shape whose curvature of an arc is locally different (for example, an elliptical shape), a shape derived from a perfect circle or a circle, and the like.

In this embodiment, the hollow part 220h is provided with deviation to one side from a center C of the tubular protrusion part 220 in the plan view (top view). The hollow part 220h is provided with deviation to the upper side in the height direction Z from the center C of the tubular protrusion part 220 here. In some embodiments, it is preferable that when the tubular protrusion part 220 is divided into two regions (halved) along an axial line CL passing the center C of the tubular protrusion part 220 in the plan view in which the tubular protrusion part 220 is viewed from the tip end side, the hollow part 220h exist with deviation (with bias) in one region as illustrated in FIG. 6. In other words, it is preferable that the tubular protrusion part 220 have the axial line CL that passes the center C of the tubular protrusion part 220 and halves the tubular protrusion part 220 in the plan view in which the tubular protrusion part 220 is viewed from the tip end side, and that the hollow part 220h exist with bias in one region of the two regions divided along this axial line CL. When the tubular protrusion part 220 is halved vertically in the height direction Z along the axial line CL passing the center C, the hollow part 220h exists with deviation in an upper region here.

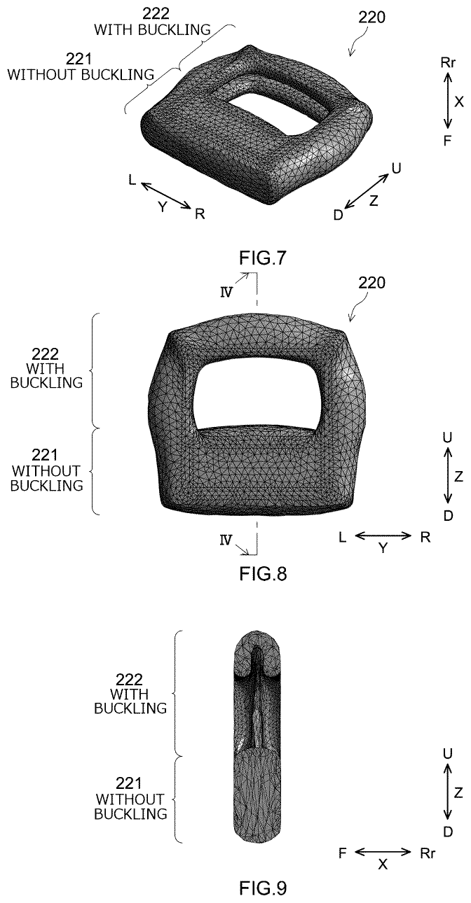

When the predetermined load is applied to the spacer 200 from the arrangement direction X, such a structure causes the first part 221 of the peripheral wall part 220w to be compressed and deformed while the second part 222 is buckled. FIG. 7 represents results of simulation in which the tubular protrusion part 220 in FIG. 5 is compressed. FIG. 8 represents results of simulation in which the tubular protrusion part 220 in FIG. 6 is compressed. FIG. 9 is a schematic longitudinal cross-sectional view taken along line IV-IV in FIG. 8. Note that FIG. 7 to FIG. 9 express the results of the simulation in which the compression rate of the tubular protrusion part 220 is 50%.

As illustrated in FIG. 7 to FIG. 9, when the tubular protrusion part 220 is compressed until the length thereof in the arrangement direction X (the projecting height Da) becomes 50% (compressed until the compression rate becomes 50%) with the load applied to the tubular protrusion part 220 from the arrangement direction X, the first part 221 is crushed in the arrangement direction X and compressed and deformed so that its cross section is enlarged compared to the state before the compression illustrated in FIG. 5 and FIG. 6. On the other hand, the second part 222 winds in an arc shape in the arrangement direction X and has a substantially C-like cross-sectional shape as illustrated in FIG. 9 in particular. In this embodiment, a force in a direction of expanding in the YZ plane is generated in the rounded part with the load from the arrangement direction X. At this time, by making the thickness of the first part 221 that is viewed in the YZ plane smaller than that of the second part 222, this winding can be generated suitably. When the first part 221 and the second part 222 are compressed in this manner, even if the electrical energy storage device 100 expands, it is possible to press the electrical energy storage device 100 stably with a predetermined restriction load and thus, the load necessary to keep the performance can be applied stably to the electrical energy storage device 100 in the art disclosed herein. The description is made below in detail.

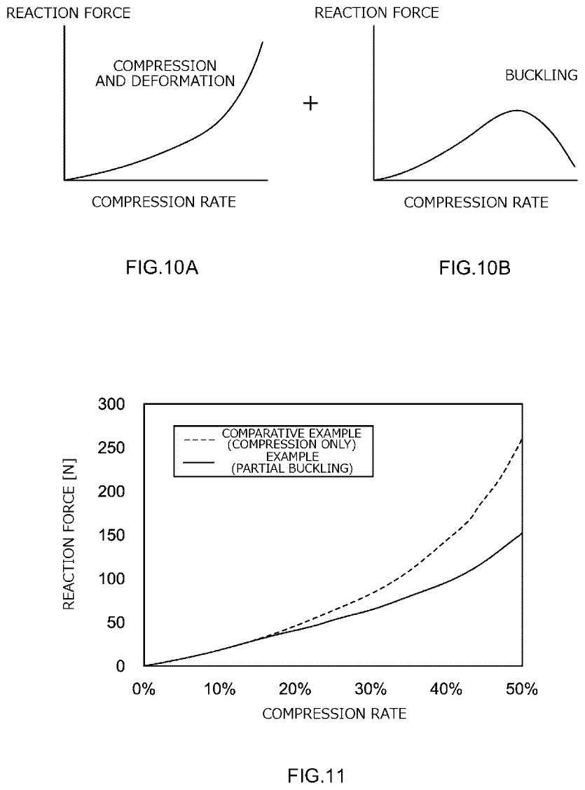

That is to say, some electrical energy storage devices may expand when the charging and discharging are repeated as described in, for example, Japanese Patent Application Publication No. 2023-84271. In particular, the electrical energy storage devices that have increased in capacity recently tend to expand largely. Thus, the compression rate of the protrusion part of the spacer tends to become high. When the compression rate of the protrusion part becomes high, just the conventional “compression and deformation” of the protrusion part cannot absorb the expansion of the electrical energy storage device completely and the reaction force for the electrical energy storage device or the like suddenly increases exponentially as expressed in FIG. 10A. If the reaction force is made too small, there is a concern that the electrical energy storage device is easily damaged due to vibration or impact.

In view of this, the present inventors have considered to reduce the reaction force by absorbing the expansion of the electrical energy storage device in such a way that, newly, the protrusion part is “buckled”. That is to say, “the buckling” refers to a phenomenon of winding (bending) due to curving upon the application of a so-called “buckling load”. Therefore, as expressed in FIG. 10B, the present inventors have considered that the reaction force can be reduced effectively by “buckling” the protrusion part when the compression rate of the protrusion part becomes high. According to the present inventors' examination, however, just “the buckling” results in the excessive reduction of the restriction load on the contrary, because the reaction force becomes too small.

Therefore, in the art disclosed herein, the tubular protrusion part 220 is provided in the spacer 200 and when the predetermined load (buckling load) is applied from the arrangement direction X, the second part 222 of the tubular protrusion part 220 is partially buckled. In other words, a part that is compressed and deformed and a part that is buckled are provided in one tubular protrusion part 220, and the absorption of the expansion by the conventional “compression and deformation” and the absorption of the expansion by the “buckling” are combined.

Thus, as represented by the results of simulation in FIG. 11, in the example according to the art disclosed herein (with the partial buckling), when the electrical energy storage device 100 expands after the charging and discharging cycle and the compression force of the tubular protrusion part 220 becomes large, the increase in reaction force can be suppressed relatively compared to a comparative example (with the compression and deformation only). As a result, the expansion of the electrical energy storage device 100 can be absorbed and the reaction force can be reduced without largely reducing the restriction load (initial load). Accordingly, the electrical energy storage device 100 can be stably pressed with the predetermined restriction load and the load necessary to keep the performance can be applied to the electrical energy storage device 100 stably. Since the first part 221 is not buckled, the minimum necessary load can be secured also when the second part 222 is buckled. In addition, since it is unnecessary to enlarge the restriction mechanism in consideration of the increase in reaction force, the energy density of the electrical energy storage module 500 can be improved.

In some embodiments, it is preferable that each of the plurality of tubular protrusion parts 220 be not rotationally symmetric (less than 360°) using the center C of the tubular protrusion part 220 as a center of symmetry in the plan view in which the tubular protrusion part 220 is viewed from the tip end side. Thus, when the restriction load is applied from the arrangement direction X, the load tends to concentrate on the second part 222 so that the second part 222 buckles easily.

In some embodiments, in the plan view in which the tubular protrusion part 220 is viewed from the tip end side, the hollow part 220h has a substantially circular shape or a substantially polygonal shape and a center Ch of the hollow part 220h is displaced from the center C of the tubular protrusion part 220 as illustrated in FIG. 6. In FIG. 6, the center Ch of the hollow part 220h is displaced to the upper side from the center C of the tubular protrusion part 220. In other words, there are a thick part and a thin part when viewed in the YZ plane. Thus, when the restriction load is applied from the arrangement direction X, the second part 222, which is thin as seen from the YZ plane, is easily bent due to the force generated in the YZ direction and the buckling easily occurs in the second part 222.

In addition, as illustrated in FIG. 4, the plurality of tubular protrusion parts 220 are aligned in the width direction Y (a first direction) and the height direction Z (a second direction) that intersect with the arrangement direction X here. Specifically, the plurality of tubular protrusion parts 220 are aligned vertically and horizontally with a constant space therebetween so as to form a plurality of columns L1 to L4 in the width direction Y and a plurality of rows in the height direction Z. In each of the columns L1 to L4 in the width direction Y, the plurality of tubular protrusion parts 220 are disposed so that each hollow part 220h is deviated to the same side. Specifically, the plurality of tubular protrusion parts 220 are disposed so that each hollow part 220h is deviated to the upper side (one side) in the height direction Z in the odd-numbered columns L1 and L3 in the width direction Y On the other hand, in the even-numbered columns L2 and L4 in the width direction Y, the plurality of tubular protrusion parts 220 are disposed so that each hollow part 220h is deviated to the lower side (the other side) in the height direction Z. The plurality of tubular protrusion parts 220 are disposed alternately in a direction of being rotated by 180° for each of the columns L1 to L4.

In some embodiments, it is preferable that, out of two of the tubular protrusion parts 220 that are adjacent to each other in the width direction Y (the first direction) intersecting with the arrangement direction X, a first one of the tubular protrusion parts 220 (for example, the tubular protrusion parts 220 in the odd-numbered columns L1 and L3) has the hollow part 220h provided with deviation to the upper side (one side) in the height direction Z (the second direction intersecting with the first direction) and a second one of the tubular protrusion parts 220 (for example, the tubular protrusion parts 220 in the even-numbered columns L2 and L4) has the hollow part 220h provided with deviation to the lower side (the other side) in the height direction Z (the second direction). By inverting the directions of the plurality of tubular protrusion parts 220 between the two adjacent tubular protrusion parts 220 in this manner, it becomes easy to apply the load with balance to the electrical energy storage devices 100 in a plane direction even when the second parts 222 are buckled.

The electrical energy storage module 500 can be used for various applications; for example, the electrical energy storage module 500 can be suitably used as a motive power source for a motor (power source for driving) that is mounted on a vehicle such as a passenger car or a truck. The vehicle is not limited to a particular type, and may be, for example, a plug-in hybrid electric vehicle (PHEV), a hybrid electric vehicle (HEV), or a battery electric vehicle (BEV).

Although the preferable embodiments of the present disclosure have been described above, they are merely examples. The present disclosure can be implemented in various other modes. The present disclosure can be implemented based on the contents disclosed in the present specification and the technical common sense in the relevant field. The techniques described in the scope of claims include those in which the embodiments exemplified above are variously modified and changed.

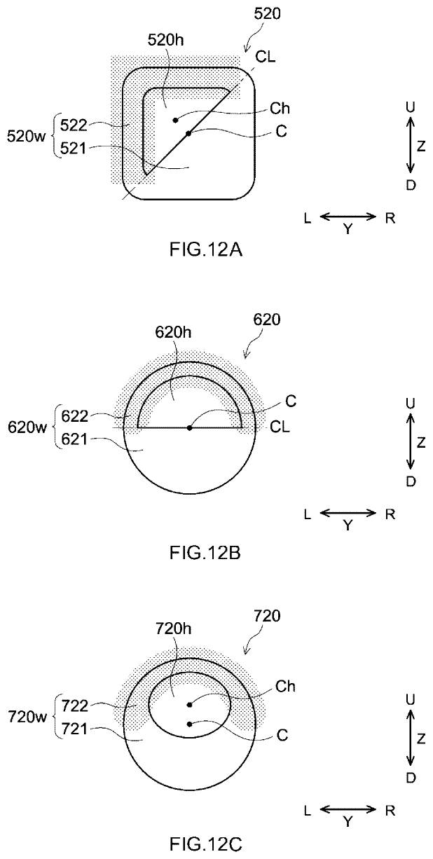

For example, in the aforementioned embodiment illustrated in FIG. 5 and FIG. 6, the outer shape of the tubular protrusion part 220 is the substantially prism shape. In addition, the outer shape of the hollow part 220h is the substantially prism shape. The outer shape of the hollow part 220h is the same as the outer shape of the tubular protrusion part 220. The hollow part 220h has a substantially quadrangular shape in the plan view. However, the present disclosure is not limited to this example. FIG. 12A to FIG. 12C are views of the tubular protrusion parts according to modifications, corresponding to FIG. 6.

### First Modification

As illustrated in FIG. 12A, a tubular protrusion part 520 according to a first modification includes a peripheral wall part 520w and a hollow part 520h surrounded by the peripheral wall part 520w. Although the illustration is omitted, the outer shape of the tubular protrusion part 520 is a substantially prism shape. The outer shape of the hollow part 520h is a substantially triangular prism shape here, which is different from the embodiment described above. The outer shape of the hollow part 520h is different from the outer shape of the tubular protrusion part 520. The hollow part 520h has a substantially triangular shape in the plan view. The hollow part 520h is provided with deviation to an upper left side from a center C of the tubular protrusion part 520. A center Ch of the hollow part 520h is displaced to the upper left side from the center C of the tubular protrusion part 520.

The peripheral wall part 520w includes a first part 521 with relatively large thickness and a second part 522 with relatively small thickness. The first part 521 has a substantially triangular shape in the plan view here. The first part 521 is provided in a block shape on a lower right side of the hollow part 520h. The second part 522 has a substantially L-like shape in the plan view here. The second part 522 includes a left part that is provided in a band shape with substantially uniform thickness along the height direction Z on a left side of the hollow part 520h, and an upper part that is provided in a band shape with substantially uniform thickness along the width direction Y on an upper side of the hollow part 520h. In this modification, only the second part 522 is buckled when the predetermined load is applied from the arrangement direction X as indicated by a shadowed part in FIG. 12A.

In some embodiments, it is preferable that when the tubular protrusion part 520 is divided into two regions (halved) along the axial line CL passing the center C of the tubular protrusion part 520 in the plan view in which the tubular protrusion part 520 is viewed from the tip end side, the hollow part 520h exist only in one region. When the tubular protrusion part 520 is obliquely halved along the axial line CL, the hollow part 520h is provided only in a region on the upper left side here. Thus, when the restriction load is applied from the arrangement direction X, the second part 522 formed to be thin as seen from the YZ plane tends to bend with respect to the force in the YZ direction that is generated in the rounded part and the buckling easily occurs in the second part 522, which is similar to the embodiment illustrated in FIG. 9.

### Second Modification

As illustrated in FIG. 12B, a tubular protrusion part 620 according to a second modification includes a peripheral wall part 620w and a hollow part 620h surrounded by the peripheral wall part 620w. Although the illustration is omitted, the outer shape of the tubular protrusion part 620 is a circular cylindrical shape, which is different from that in the embodiment described above. Here, the outer shape of the hollow part 620h is a semi-circular cylindrical shape, which is different from that in the embodiment described above. The outer shape of the hollow part 620h is different from the outer shape of the tubular protrusion part 620. The outer shape of the hollow part 620h is a semi-circular shape in the plan view. The hollow part 620h is provided with deviation to the upper side from a center C of the tubular protrusion part 620. Specifically, when the tubular protrusion part 620 is halved vertically in the height direction Z along the axial line CL, the hollow part 620h is provided in an upper half region.

The peripheral wall part 620w includes a first part 621 with relatively large thickness and a second part 622 with relatively small thickness. The first part 621 has a substantially semi-circular shape in the plan view here. The first part 621 is provided in a block shape on a lower side of the hollow part 620h. The first part 621 is provided in a lower half region of the tubular protrusion part 620. The second part 622 has a substantially C-like shape in the plan view here. The second part 622 is provided on an upper side of the hollow part 620h along an arc of the hollow part 620h. In this modification, only the second part 622 is buckled when the predetermined load is applied from the arrangement direction X as indicated by a shadowed part in FIG. 12B.

### Third Modification

As illustrated in FIG. 12C, a tubular protrusion part 720 according to a third modification includes a peripheral wall part 720w and a hollow part 720h surrounded by the peripheral wall part 720w. The outer shape of the hollow part 720h is a circular cylindrical shape, which is different from that in the second modification in FIG. 12B described above. The hollow part 720h has a substantially circular shape in the plan view. The hollow part 720h is provided with deviation to an upper side from a center C of the tubular protrusion part 720. A center Ch of the hollow part 720h is displaced to the upper side from the center C of the tubular protrusion part 720.

The peripheral wall part 720w includes a first part 721 with relatively large thickness and a second part 722 with relatively small thickness. The thickness of the second part 722 gradually increases toward the first part 721. In this modification, only the second part 722 is buckled when the predetermined load is applied from the arrangement direction X as indicated by a shadowed part in FIG. 12C.

As described above, the following items are given as specific aspects of the art disclosed herein.

Item 1: The electrical energy storage module including: the first electrical energy storage device and the second electrical energy storage device that are disposed along the arrangement direction; the spacer that is disposed between the first electrical energy storage device and the second electrical energy storage device; and the restriction member that restricts the first electrical energy storage device, the second electrical energy storage device, and the spacer in the arrangement direction, in which the spacer includes the base part with the flat plate shape, and the plurality of tubular protrusion parts projecting from the base part to the side of the first electrical energy storage device, each of the plurality of tubular protrusion parts includes the peripheral wall part extending to the side of the first electrical energy storage device, and the hollow part surrounded by the peripheral wall part, the peripheral wall part includes the first part with the relatively large thickness and the second part with the relatively small thickness, the hollow part is provided with deviation to one side from the center of the tubular protrusion part in the plan view, and when the predetermined load is applied from the arrangement direction, the first part of the peripheral wall part is compressed and deformed and the second part of the peripheral wall part is buckled.

Item 2: The electrical energy storage module according to Item 1, in which each of the plurality of tubular protrusion parts is not rotationally symmetric using the center of the tubular protrusion part as the center of symmetry in the plan view.

Item 3: The electrical energy storage module according to Item 1 or 2, in which the hollow part has the substantially circular shape or the substantially polygonal shape and the center of the hollow part is displaced from the center of the tubular protrusion part in the plan view.

Item 4: The electrical energy storage module according to any one of Items 1 to 3, in which when the tubular protrusion part is divided into two regions along the axial line passing the center of the tubular protrusion part in the plan view, the hollow part is provided only in one region.

Item 5: The electrical energy storage module according to any one of Items 1 to 4, in which out of two of the tubular protrusion parts that are adjacent to each other in the first direction intersecting with the arrangement direction, the first one of the tubular protrusion parts has the hollow part provided with deviation to one side in the second direction intersecting with the first direction and the second one of the tubular protrusion parts has the hollow part provided with deviation to the other side in the second direction.

Item 6: The spacer for the electrical energy storage module, the spacer being disposed between the first electrical energy storage device and the second electrical energy storage device that are disposed along the arrangement direction, and including: the base part with the flat plate shape, and the plurality of tubular protrusion parts projecting from the base part to the side of the first electrical energy storage device, in which each of the plurality of tubular protrusion parts includes the peripheral wall part extending to the side of the first electrical energy storage device, and the hollow part surrounded by the peripheral wall part, the peripheral wall part includes the first part with the relatively large thickness and the second part with the relatively small thickness, the hollow part is provided with deviation to one side from the center of the tubular protrusion part in the plan view, and when the predetermined load is applied from the arrangement direction, the first part of the peripheral wall part is compressed and deformed and the second part of the peripheral wall part is buckled.

What is claimed is:

1. An electrical energy storage module comprising:
a first electrical energy storage device and a second electrical energy storage device that are disposed along an arrangement direction;
a spacer that is disposed between the first electrical energy storage device and the second electrical energy storage device; and
a restriction mechanism that restricts the first electrical energy storage device, the second electrical energy storage device, and the spacer in the arrangement direction, wherein
the spacer includes a base part with a flat plate shape, and a plurality of tubular protrusion parts projecting from the base part to a side of the first electrical energy storage device,
each of the plurality of tubular protrusion parts includes a peripheral wall part extending to the side of the first electrical energy storage device, and a hollow part surrounded by the peripheral wall part,
the peripheral wall part includes a first part with relatively large thickness and a second part with relatively small thickness,
the hollow part is provided with deviation to one side from a center of the tubular protrusion part in a plan view, and
when a predetermined load is applied from the arrangement direction, the first part of the peripheral wall part is compressed and deformed and the second part of the peripheral wall part is buckled.

2. The electrical energy storage module according to claim 1, wherein each of the plurality of tubular protrusion parts is not rotationally symmetric using the center of the tubular protrusion part as a center of symmetry in the plan view.

3. The electrical energy storage module according to claim 1, wherein the hollow part has a substantially circular shape or a substantially polygonal shape and a center of the hollow part is displaced from the center of the tubular protrusion part in the plan view.

4. The electrical energy storage module according to claim 1, wherein when the tubular protrusion part is divided into two regions along an axial line passing the center of the tubular protrusion part in the plan view, the hollow part is provided only in one region.

5. The electrical energy storage module according to claim 1, wherein out of two of the tubular protrusion parts that are adjacent to each other in a first direction intersecting with the arrangement direction, a first one of the tubular protrusion parts has the hollow part provided with deviation to one side in a second direction intersecting with the first direction and a second one of the tubular protrusion parts has the hollow part provided with deviation to the other side in the second direction.

6. A spacer for an electrical energy storage module, the spacer being disposed between a first electrical energy storage device and a second electrical energy storage device that are disposed along an arrangement direction, and comprising:
a base part with a flat plate shape, and a plurality of tubular protrusion parts projecting from the base part to a side of the first electrical energy storage device, wherein
each of the plurality of tubular protrusion parts includes a peripheral wall part extending to the side of the first electrical energy storage device, and a hollow part surrounded by the peripheral wall part,
the peripheral wall part includes a first part with relatively large thickness and a second part with relatively small thickness,
the hollow part is provided with deviation to one side from a center of the tubular protrusion part in a plan view, and
when a predetermined load is applied from the arrangement direction, the first part of the peripheral wall part is compressed and deformed and the second part of the peripheral wall part is buckled.
